(19) United States
(12) Patent Application Publication
(10) Pub. No.: US 2016/0147783 A1
(43) Pub. Date: May 26, 2016

(54) REPOSITORY-BASED DATA CACHING APPARATUS FOR CLOUD RENDER FARM AND METHOD THEREOF

(71) Applicant: CLUNIX CO., LTD., Seoul (KR)

(72) Inventor: Kyung-Woon CHO, Seoul (KR)

(21) Appl. No.: 14/552,974

(22) Filed: Nov. 25, 2014

(51) Int. Cl. G06F 17/30; H04L 29/08; G06T 1/20

(52) U.S. Cl. CPC G06F 17/30132; G06T 1/20; H04L 67/2842; G06F 17/30203; H04L 67/1097; G06T 2200/28

(57) ABSTRACT

Provided are an apparatus for caching data stored in a repository in a server on a cloud that performs a rendering work, so as to perform a computer graphic rendering work on a common cloud, and a method thereof. The data caching apparatus includes a rendering repository server, and a plurality of rendering servers including a cache client.

### BACKGROUND OF THE INVENTION

1. Field of the Invention

The present invention relates to an apparatus for caching data stored in a repository in a server on a cloud that performs a rendering work, so as to perform a computer graphic rendering work on a common cloud, and a method thereof.

2. Description of the Related Art

Very many computing resources are required in a computer graphic rendering work that is widely used in a movie, an advertisement, and an animation (see FIG. 1).

A computer graphic company can perform a computer graphic rendering work using a render farm that the computer graphic company possesses. The render farm is configured in various scales from 10 personal computers (PCs) to several hundreds of servers and has a structure in which a common storage between internal servers is set and an identical input file is used.

However, computer graphic workers should use files stored in the common storage so as to generate or edit graphic files. In this case, interference with servers of the render farm may occur. Thus, the common storage is usually classified into a common storage for a worker and a common storage for the render farm, and copying between two common storages is performed by a manual work.

In order to perform the computer graphic rendering work, the computer graphic company can perform the computer graphic rendering work on a common cloud, such as Amazon, rather than possess the render farm of the computer graphic company.

A render farm that exists on a cloud, according to the related art, uses a method, whereby data is uploaded to the cloud and then rendering is executed for the computer graphic company based on the uploaded data.

However, a method, whereby the entire data required in a rendering work is uploaded to the cloud and the rendering work is performed, has the following problems.

First, rendering starts being performed after uploading of the entire data is finished, such that a work may be delayed.

Second, it is inconvenient to upload the entire data whenever computer graphic workers modify files, if only the modified files cannot be transmitted.

A more important problem is that computer graphic original data for rendering is a very important asset to the computer graphic company and thus in an aspect of security, it is very vulnerable to manage the computer graphic original data on the cloud.

### PRIOR-ART DOCUMENTS

(Patent document 1) Korean Patent Laid-open Publication No. 10-2012-0086175 (published on Aug. 2, 2012)

(Patent document 2) Korean Patent Laid-open Publication No. 10-2011-0111240 (published on Oct. 10, 2011)

(Patent document 3) Korean Patent Laid-open Publication No. 10-2011-0073164 (published on Jun. 29, 2011)

### SUMMARY OF THE INVENTION

The present invention provides a data caching apparatus and method, whereby data stored in a repository can be effectively synchronized in a server on a cloud that performs a rendering work.

Objectives of the present invention are not limited to the objectives mentioned above, and other unmentioned objectives will be clearly understood by one of ordinary skill in the art from the following description.

According to an aspect of the present invention, there is provided a repository-based data caching apparatus for a cloud render farm, including: a rendering repository server including a cache server that stores data files required for rendering according to a revision history and transmits the corresponding data files to a rendering server according to a request of a cache client; and a plurality of rendering servers including a cache client that acquires a renderer software (S/W) performing a given rendering work and revision information regarding the corresponding data files using a revision tree that has been already registered to correspond to the renderer S/W according to an input/output request of the data files of the renderer S/W, that loads the corresponding data files from a local cache pool using path information and revision information of the corresponding data files, and if the corresponding data files do not exist in the local cache pool, that provides the path information and the revision information of the corresponding data files to the cache server and stores the data files transmitted from the repository server in the local cache pool.

The repository-based data caching apparatus may further include a scheduler that transmits the renderer S/W and the revision tree to the plurality of rendering servers and distributes a rendering work to each of the plurality of rendering servers.

Each rendering server may further include an executor that drives the renderer S/W by receiving the renderer S/W and the revision tree from the scheduler, makes the received revision tree to correspond to the renderer S/W and registers the revision tree.

The cache client may check whether the corresponding data files exist in the cache pool of another rendering server that constitutes a cloud render farm before requesting the cache server of the data files.

According to another aspect of the present invention, there is provided a data caching method, whereby each of rendering severs that constitute a cloud render farm caches data based on a repository, the data caching method including: (a) driving a renderer software (S/W), making a revision tree to correspond to the renderer S/W and registering the revision tree; (b) acquiring revision information of corresponding data files using the revision tree corresponding to the renderer S/W according to an input/output request of the data files of the renderer S/W; (c) loading the corresponding data files from a local cache pool using path information and the revision information of the corresponding data files; and (d) if the corresponding data files do not exist in the local cache pool, providing the path information and the revision information of the corresponding data files to a repository server, storing the data files transmitted from the repository server and loading the corresponding data files from the local cache pool.

(b) may include: (b1) transmitting path information to a user-level filesystem using the renderer S/W and requesting input/output of the data files; (b2) transmitting the path information and a process identification (ID) of the renderer S/W to the cache client and requesting file processing using the user-level filesystem; and (b3) acquiring revision information of the corresponding data files using a revision tree corresponding to the process ID of the renderer S/W using the cache client.

The data caching method may further include, before (d), (c1) checking whether the corresponding data files exist in the cache pool of another rendering server that constitutes a cloud render farm, and if the corresponding data files exist in the cache pool of another rendering server, receiving the corresponding data files, storing the data files in the local cache pool and loading the corresponding data files from the local cache pool.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual view of a process of performing computer graphic modeling and rendering;

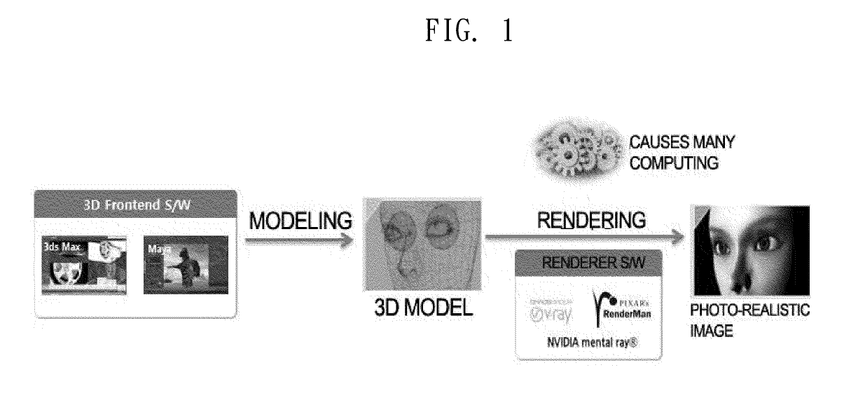

FIG. 2 is a view of an ambient environment of a repository-based data caching apparatus for a cloud render farm according to an embodiment of the present invention;

FIG. 3 is a block diagram of the repository-based data caching apparatus for the cloud render farm illustrated in FIG. 2;

FIG. 4 is a view of a snapshot in a process of modifying a file revision;

FIG. 5 is a view of an example of a configuration of a revision tree according to the present invention;

FIG. 6 is a view of an example of a configuration of a user process table according to the present invention; and

FIG. 7 is a flowchart illustrating a repository-based data caching method for a cloud render farm according to an embodiment of the present invention.

### DETAILED DESCRIPTION OF THE INVENTION

The present invention will now be described more fully with reference to the accompanying drawings, in which exemplary embodiments of the invention are shown.

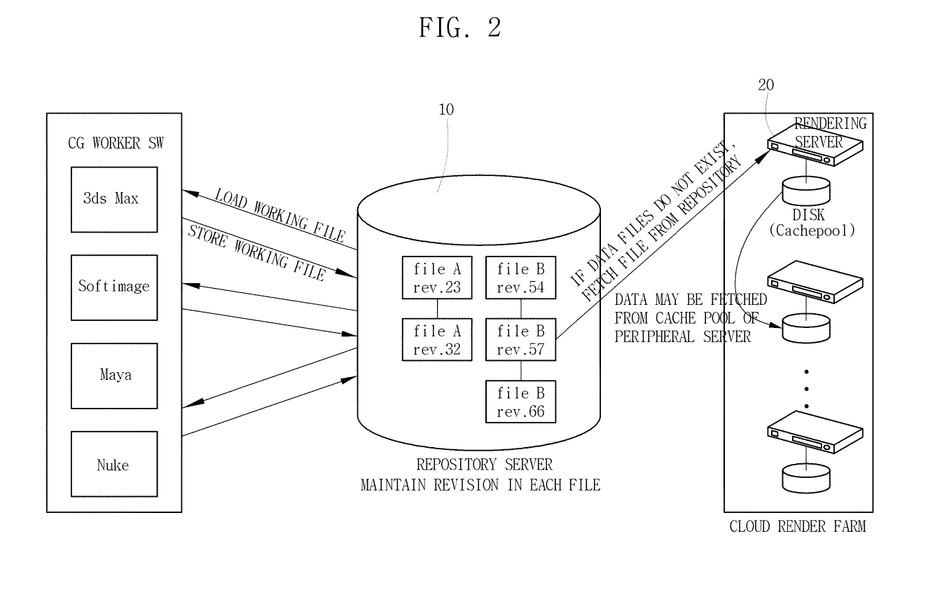

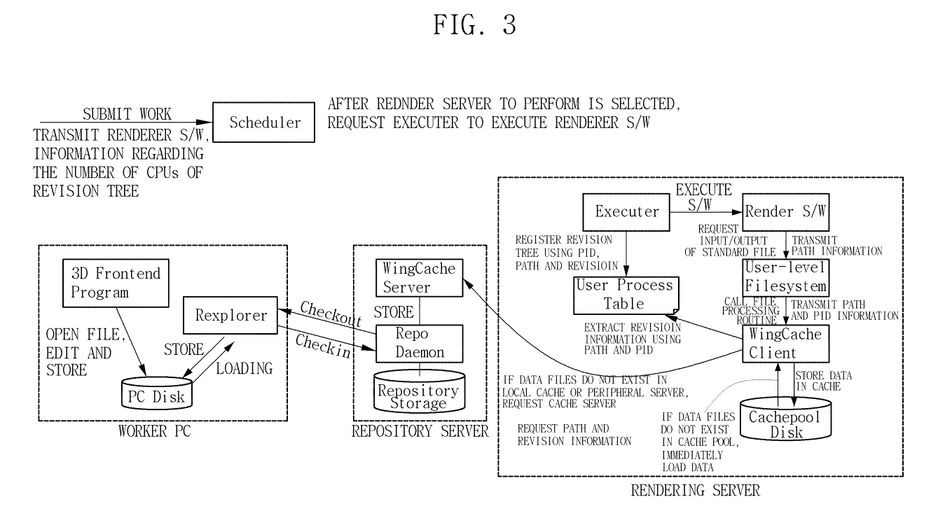

FIG. 2 is a view of an ambient environment of a repository-based data caching apparatus for a cloud render farm according to an embodiment of the present invention, and FIG. 3 is a block diagram of the repository-based data caching apparatus for the cloud render farm illustrated in FIG. 2.

As illustrated in FIGS. 2 and 3, the repository-based data caching apparatus for a cloud render farm according to the present invention (hereinafter, for conveniences, referred to as ‘WingCache’) is realized by a repository server 10 and a plurality of rendering servers 20.

The repository server 10 is a storage space in which the repository server 10 is connected to many worker personal computers (PCs) 30 and computer graphic workers create and edit files. The repository server 10 has checkin, checkout, and revision history functions. Also, the repository server 10 is connected to the plurality of rendering servers 20 that constitute the cloud render farm and includes a cache server 12 that stores data files required for rendering and transmits the data files to the rendering servers 20 according to a request of a cache client 33.

A three-dimensional (3D) graphic processing work has a pipeline structure in which many workers who have division of labor cooperate and develop. The 3D graphic processing work requires an enormous amount of data, such as many 3D input models, textures, shaders, and animation scripts and is continuously modified. Thus, the repository server 10 according to the present invention manages and accumulates a large amount of data as a version whenever workers modify the large amount of data and simultaneously supports flexible data sharing between the workers.

Most data stored in the repository server 10 is binary data. A storage method in units of a revision file is adopted rather than a modifying part storage method that is used in a general source code control system.

In the 3D graphic processing work, each worker edits different files and thus, simultaneous editing of a single file occurs hardly. Thus, in the repository server 10 according to the present invention, a file checkout mode is classified into two types, i.e., a read-only checkout mode and a read/write checkout mode. In the case of the read/write checkout mode, the read-only checkout mode is not allowed, and a checkout user can read files.

The repository server 10 according to the present invention disallows simultaneous editing. Thus, conflict does not occur in check-in so that general users can easily use the repository server 10. Since most workers perform editing of a single file, the repository server 10 does not provide a function of checking in several files at a time and is specialized in a single file check-in function.

A cooperation work between workers in the 3D graphic pipeline structure is mainly performed with the latest files and thus is simplified as a single trunk model having no work division function, such as Branch or Merge.

In the repository server 10 according to the present invention, a repository storage 16 is configured based on a general file system. That is, the repository storage 16 is configured by a repository hierarchy structure that is the same as a file system hierarchy structure. In the repository hierarchy structure according to the present invention, repository meta information is stored in a binary format in a specific file (.repometa) of a top-level folder, and a specific folder (.rev) for storing meta information for each file is created in each folder.

Files stored in the repository storage 16 increase a revision by one whenever they are modified, and a repository revision is the largest revision number among the entire files stored in the repository storage 16.

In file checkin and checkout on the repository sever 10, meta information recording and file storage/movement are performed by Repo GateKeeper server Daemon 14.

The worker may personally perform checkin and checkout processes onto a working folder using a repository client tool.

A program, for example, Maya, 3ds Max, which is provided by a third development application program interface (API) having a plugin shape of a 3D frontend program 32 may automatically perform checkout by opening files on the repository server 10 on an application and may perform checkin onto the repository server 10 using a storing function after editing.

The repository server 10 according to the present invention may provide a function of deleting an unused old version at a time so as to improve space utilization. The workers randomly create replica and waste a space due to useless files based on an existing share storage. In the present invention, a user may selectively designate the maximum number of revisions that are retained in each folder and may reduce a burden of managing the old revisions.

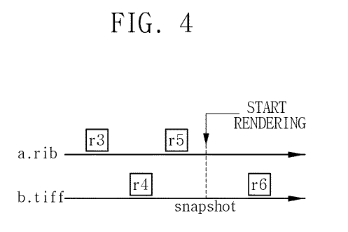

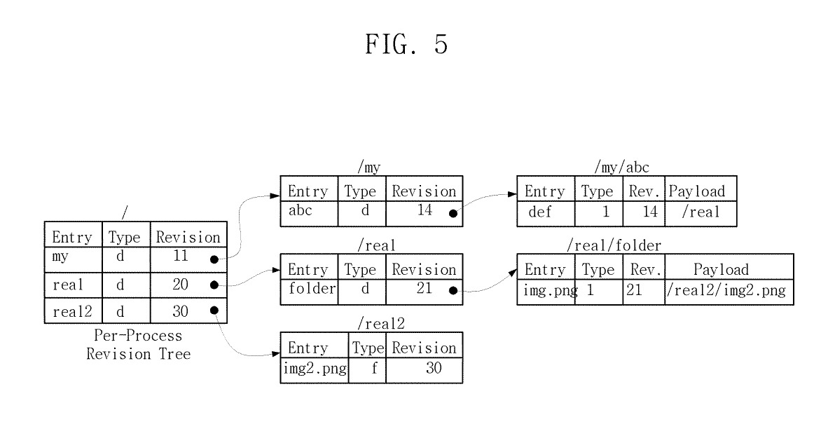

When the rendering work is submitted, a revision tree in which a repository revision when the rendering work is submitted, is set as a snapshot version of rendering input files, should be provided to a scheduler 40 together with a renderer software (S/W) 21, and the number of central processing units (CPUs) required for the work may be set. FIG. 4 is a view of a snapshot in a process of modifying a file revision. The revision tree is information based on a tree including revision information in each file of the file system hierarchy structure, as illustrated in FIG. 5.

The scheduler 40 selects rendering servers to perform the work from among rendering servers that constitute the cloud render farm according to the number of CPUs required for the work and transmits the renderer S/W 21 and the revision tree to the selected rendering servers, thereby distributing the rendering work.

Each rendering server 20 includes an executer 25, a user-level filesystem 22, a cache client 23, and a cache pool 24.

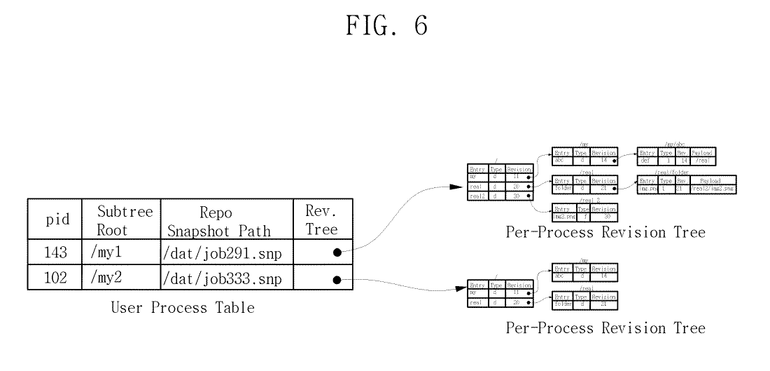

The executer 25 drives the renderer S/W 21 by receiving the renderer S/W 21 and the revision tree from the scheduler 40. Also, the executer 25 makes the received revision tree to correspond to a process identification (ID) pid of the driven renderer S/W 21 and registers the process ID pid in a user process table 26 illustrated in FIG. 6.

The driven renderer S/W 21 transmits path information to the user-level filesystem 22 and requires input/output of a corresponding data file when input/output of the data file is required.

The user-level filesystem 22 transmits the received path information and the process ID pid of the renderer S/W 21 to the cache client 23 and requests file processing.

The cache client 23 searches for the revision tree corresponding to the process ID pid of the renderer S/W 21 by referring to the user process table 26 and acquires revision information of the corresponding data file from the searched-for revision tree. The cache client 23 loads the corresponding data file from the local cache pool 24 using the path information and the revision information of the corresponding data file. In this case, if the corresponding data file does not exist in the local cache pool 24, the cache client 23 checks whether the corresponding data file exists in a cache pool of another rendering server that constitutes the cloud render farm. If it is checked that the corresponding data file exists in the cache pool of another rendering server, the cache client 23 receives the corresponding data file and stores the corresponding data file in the local cache pool 24. Also, if it is checked that the corresponding data file does not exist in the cache pool of another rendering server, the cache client 23 provides the path information and the revision information of the corresponding data file to a cache server 12 and stores a data file transmitted from the repository server 10 in the local cache pool 24.

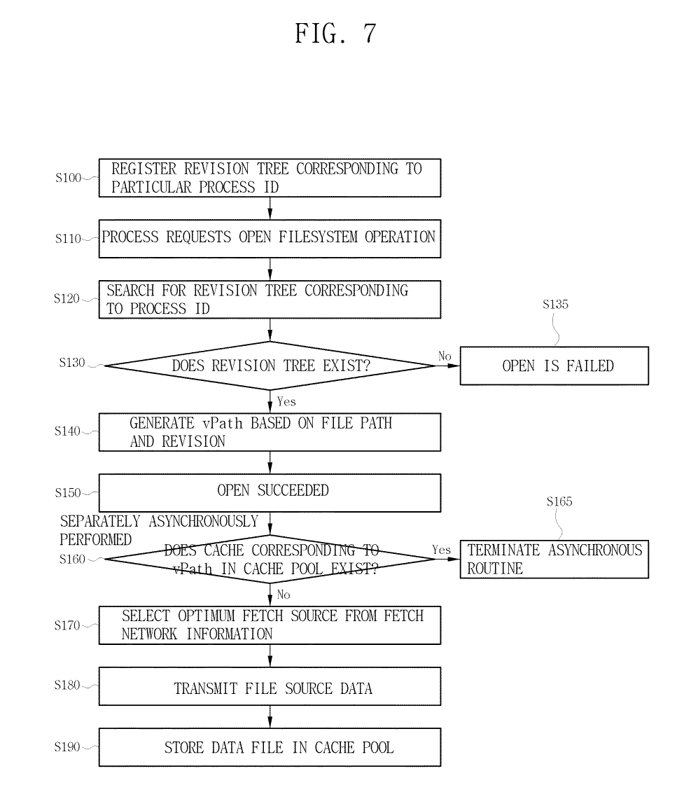

Hereinafter, a repository-based data caching method using each rendering server that constitutes the cloud render farm will be described in detail with reference to FIG. 7.

The executer 25 of the rendering server 20 drives the renderer S/W 21 by receiving the renderer S/W 21 and the revision tree from the scheduler 40. Subsequently, the executer 25 makes the received revision tree to correspond to the process ID pid of the renderer S/W 21 and registers the revision tree in the user process table 26 (S100).

The renderer S/W 21 requests input/output of a required data file by performing a work (S110). In this case, since the renderer S/W 21 is an application program that operates on the rendering server 20, the renderer S/W 21 provides only path information of the corresponding data file and requires input/output of a standard file toward the user-level filesystem 22. Thus, the user-level filesystem 22 cannot know revision information regarding the corresponding data file.

The user-level filesystem 22 transmits the path information and the process ID pid of the renderer S/W 21 to the cache client 23 and requests file processing. Then, the cache client 23 searches for the revision tree corresponding to the process ID pid of the renderer S/W 21 by referring to the user process table 26 (S120). In this case, if no corresponding revision tree exists, it is acknowledged that file opening is failed (S130 and S135), and if the corresponding revision tree exists, the cache client 23 acquires the revision information of the corresponding data file using the corresponding revision tree and creates a virtual path vPath together with the received path information (S140), and it is acknowledged that file opening succeeded, by loading the corresponding data file from the local cache pool 24 using the virtual path vPath (S150).

If the path information is/abc/def.txt and the revision information is 25, the virtual path vPath is created in the form of/abc/def.txt@25.

The subsequent work is asynchronously performed. First, it is checked whether a cache on the virtual path vPath exists in the local cache pool 24.

If the corresponding cache (data file) exists in the local cache pool 24, an asynchronous routine is terminated (S160 and S165). If the corresponding cache does not exist in the local cache pool 24, an additional algorithm for selecting an optimum fetch source from a fetch network is performed (S170). Here, the fetch network includes the repository server 10 and peripheral rendering servers that constitute the cloud render farm.

For example, it is checked whether the corresponding data file exists in a cache pool of another rendering server that constitutes the cloud render farm, and if it is checked that the corresponding data file exists, the corresponding data file is transmitted and is stored in the local cache pool 24 (S180 and S190). If the corresponding data file does not exist in the cache pool of another rendering server, the path information and the revision information of the corresponding data file are provided to the repository server 10, and the corresponding data file is received from the repository server 10 and is stored in the local cache pool 24 (S180 and S190).

According to the present invention, rendering servers that constitute the cloud render farm perform a rendering work using a snapshot of files at a particular point of time, and workers create modified contents as a new revision on a repository sever so that dependency between the workers and the rendering servers that constitute the cloud render farm can be removed.

In addition, according to the present invention, not caching in units of a block but caching in units of a file is used, and files stored in a cache pool are not modified while the rendering work is performed so that there is no overhead for guaranteeing cache consistency.

Furthermore, according to the present invention, before data files that do not exist in a local cache pool are fetched from the repository server, first, it is checked whether the corresponding data files can be fetched from the cache pool of another rendering server that constitutes the cloud render farm, so that a bottleneck phenomenon of the repository server cannot be avoided.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A repository-based data caching apparatus for a cloud render farm, comprising:
a rendering repository server comprising a cache server that stores data files required for rendering according to a revision history and transmits the corresponding data files to a rendering server according to a request of a cache client; and
a plurality of rendering servers comprising a cache client that acquires a renderer software (S/W) performing a given rendering work and revision information regarding the corresponding data files using a revision tree that has been already registered to correspond to the renderer S/W according to an input/output request of the data files of the renderer S/W, that loads the corresponding data files from a local cache pool using path information and revision information of the corresponding data files, and if the corresponding data files do not exist in the local cache pool, that provides the path information and the revision information of the corresponding data files to the cache server and stores the data files transmitted from the repository server in the local cache pool.

2. The repository-based data caching apparatus of claim 1, further comprising a scheduler that transmits the renderer S/W and the revision tree to the plurality of rendering servers and distributes a rendering work to each of the plurality of rendering servers.

3. The repository-based data caching apparatus of claim 2, wherein each rendering server further comprises an executor that drives the renderer S/W by receiving the renderer S/W and the revision tree from the scheduler, makes the received revision tree to correspond to the renderer S/W and registers the revision tree.

4. The repository-based data caching apparatus of claim 1, wherein the cache client checks whether the corresponding data files exist in the cache pool of another rendering server that constitutes a cloud render farm before requesting the cache server of the data files.

5. A data caching method, whereby each of rendering severs that constitute a cloud render farm caches data based on a repository, the data caching method comprising:
(a) driving a renderer software (S/W), making a revision tree to correspond to the renderer S/W and registering the revision tree;
(b) acquiring revision information of corresponding data files using the revision tree corresponding to the renderer S/W according to an input/output request of the data files of the renderer S/W;
(c) loading the corresponding data files from a local cache pool using path information and the revision information of the corresponding data files; and
(d) if the corresponding data files do not exist in the local cache pool, providing the path information and the revision information of the corresponding data files to a repository server, storing the data files transmitted from the repository server and loading the corresponding data files from the local cache pool.

6. The data caching method of claim 5, wherein (b) comprises:
(b1) transmitting path information to a user-level filesystem using the renderer S/W and requesting input/output of the data files;
(b2) transmitting the path information and a process identification (ID) of the renderer S/W to the cache client and requesting file processing using the user-level filesystem; and
(b3) acquiring revision information of the corresponding data files using a revision tree corresponding to the process ID of the renderer S/W using the cache client.

7. The data caching method of claim 5, further comprising, before (d), (c1) checking whether the corresponding data files exist in the cache pool of another rendering server that constitutes a cloud render farm, and if the corresponding data files exist in the cache pool of another rendering server, receiving the corresponding data files, storing the data files in the local cache pool and loading the corresponding data files from the local cache pool.
